(19) United States
(12) Patent Application Publication
(10) Pub. No.: US 2026/0199946 A1
(43) Pub. Date: Jul. 16, 2026

(54) PRODUCTION AND PROCESSING EQUIPMENT FOR OXYGEN-FREE COPPER ALLOY THICK STRIPS AND PROCESSING METHOD THEREOF

(71) Applicants: Tongling University, Tongling (CN); Jinvi Copper Corporation, Tongling Nonferrous Metals Group Holding Co., Ltd., Tongling (CN)

(72) Inventors: Zheng CHEN, Tongling (CN); Jing QIN, Tongling (CN); Tongsheng HU, Tongling (CN); Chen ZHOU, Tongling (CN); Lvchuan ZHOU, Tongling (CN); Xun LI, Tongling (CN); Ping YU, Tongling (CN); Yong WANG, Tongling (CN); Tingting FU, Tongling (CN); Shengli CAO, Tongling (CN); Youlong WANG, Tongling (CN); Yang DONG, Tongling (CN)

(73) Assignees: Tongling University, Tongling (CN); Jinvi Copper Corporation, Tongling Nonferrous Metals Group Holding Co., Ltd., Tongling (CN)

(21) Appl. No.: 19/422,486

(22) Filed: Dec. 17, 2025

(30) Foreign Application Priority Data
Jan. 14, 2025 (CN) 202510054309.7

(51) Int. Cl. B21B 1/30; B21B 1/38; B21B 35/12; B21B 45/02; B21B 47/00; C21D 8/0221; C21D 8/0247; C21D 9/56; C22C 9/00

(52) U.S. Cl. CPC B21B 1/30; B21B 35/12; B21B 45/0275; B21B 47/00; C21D 8/0226; C21D 8/0263; C21D 9/561; C22C 9/00; B21B 2001/386

(57) ABSTRACT

The present invention discloses production and processing equipment for oxygen-free copper alloy thick strips and a processing method thereof, relating to the technical field of oxygen-free copper alloy processing. The equipment includes a cooling box and a pickling box. Both the cooling box and the pickling box are internally provided with a transmission mechanism, and the cooling box is internally provided with a relief mechanism for rapidly cooling an oxygen-free copper alloy plate and reducing the thickness of an oxide layer. The cooling box is internally provided with a pumping mechanism, and the pickling box is internally provided with a cleaning mechanism for performing pickling treatment on the oxide layer. The pickling box is internally provided with a polishing mechanism for removing the oxide layer on a surface of the oxygen-free copper alloy plate.

### CROSS-REFERENCE TO RELATED APPLICATIONS

The application claims priority to Chinese patent application No. 202510054309.7, filed on Jan. 14, 2025 the entire contents of which are incorporated herein by reference.

### TECHNICAL FIELD

The present invention relates to the technical field of oxygen-free copper alloy processing, and specifically relates to production and processing equipment for oxygen-free copper alloy thick strips and a processing method thereof.

### BACKGROUND

Oxygen-free copper refers to pure copper that contains no oxygen and no residual deoxidizers. In practice, however, it still contains extremely trace amounts of oxygen and certain impurities. According to relevant standards, the oxygen content shall not exceed 0.003%, the total impurity content shall not exceed 0.05%, and the copper purity shall be greater than 99.95%. Due to its high electrical conductivity and excellent processing and welding performance, oxygen-free copper is often used in the manufacture of high-end electrical devices, wires and cables, motors, high-vacuum electronic devices and the like, and is widely favored in the power electronics field.

Oxygen-free copper alloy thick strips are widely applied in the electro-vacuum industry. In the production process of oxygen-free copper alloy thick strips, oxygen-free copper alloy plates need to undergo processes such as hot rolling and annealing. During both hot rolling and annealing, the temperature of the oxygen-free copper alloy plates exceeds 600° C., which leads to oxidation of the oxygen-free copper alloy plates. After hot rolling, the temperature of the oxygen-free copper alloy plates is approximately 350° C., and after annealing, the temperature of the oxygen-free copper alloy plates is approximately 200° C. In this case, the oxygen-free copper alloy plates need to be placed in a water tank for rapid cooling. However, due to the excessively high temperature of the oxygen-free copper alloy plates, a large amount of water vapor and other gases are generated when they are immersed in water. These gases form bubbles in the water and the bubbles float on the surface of the copper alloy, resulting in a reaction between copper, water, and oxygen. This increases the thickness of the oxide layer on the surface of the oxygen-free copper alloy plates, bringing inconvenience to the subsequent treatment of the oxide layer.

### SUMMARY

The present invention aims to provide production and processing equipment for oxygen-free copper alloy thick strips and a processing method thereof, so as to solve the problems raised in the aforementioned background art.

To achieve the above objective, the present invention provides the following technical solution: production and processing equipment for oxygen-free copper alloy thick strips, which includes a cooling box and a pickling box. Both the cooling box and the pickling box are internally provided with a transmission mechanism for driving the movement of an oxygen-free copper alloy plate, and the cooling box is internally provided with a relief mechanism for rapidly cooling the oxygen-free copper alloy plate and reducing the thickness of an oxide layer.

The relief mechanism includes conveying pipes and a baffle plate. The baffle plate with an arc-shaped edge is installed inside the top of the cooling box, and the conveying pipes are symmetrically installed on upper and lower sides of the transmission mechanism inside the cooling box.

A plurality of nozzles and turning nozzles are installed on an upper side of the conveying pipe located at the lower side of the transmission mechanism, and a plurality of downward pressure nozzles are installed at a bottom end of the conveying pipe located at the upper side of the transmission mechanism.

Inclination angles of the nozzles increase sequentially from a middle position of the conveying pipe to an edge position of the conveying pipe. The turning nozzles are obliquely fixed at two ends of the conveying pipe and are located outside the nozzles.

Distances between adjacent downward pressure nozzles and inclination angles of the downward pressure nozzles gradually increase from an edge position of the conveying pipe to a middle position of the conveying pipe.

The cooling box is internally provided with a pumping mechanism for delivering water and gas to the interior of the pickling box, and the pickling box is internally provided with a cleaning mechanism for performing pickling treatment on the oxide layer.

The cleaning mechanism includes support rods. A plurality of support rods are installed inside the pickling box, and the support rods are connected to a communicating pipe through joints. The interior of each joint is rotatably connected with a rotating shaft and compression rods, enabling the rotating shaft to rotate freely within the joint. A side wall of the rotating shaft is fixedly connected with a plurality of compression rods.

A lever is rotatably connected inside each joint and the corresponding support rod, and a spherical end of the lever abuts against a lower side of the compression rod.

A piston and a sliding rod are slidably connected inside the support rod, and a top end of the sliding rod is sleeved inside the piston.

A bottom end of the lever abuts against the top of the piston, and the lever is installed on an inner side wall of the support rod through a support.

A spring sleeves a side wall of the sliding rod, and two ends of the spring respectively abut against a bottom surface of the piston and a bottom sealing surface of the support rod.

A bottom end of the sliding rod is fixedly connected to a pressing plate, and rubber pads are installed on a side wall of the pressing plate. A plurality of rubber pads are slidably connected to a top surface and a bottom surface of the oxygen-free copper alloy plate.

The pickling box is internally provided with a polishing mechanism for removing the oxide layer on a surface of the oxygen-free copper alloy plate, and two ends of the pickling box are provided with scouring mechanisms for removing the oxide layer at edges of side walls of the oxygen-free copper alloy plate.

Preferably, the transmission mechanism includes a transmission rod and a sliding cylinder. The transmission rod is located at a tail end of the sliding cylinder and extends to a tail end of the cooling box. The sliding cylinder is arranged at an entrance of the cooling box. A plurality of discharging rollers are provided at a transition position between the transmission rod and the sliding cylinder. A plurality of protrusions are installed on a side wall of the discharging roller, and lengths of the protrusions on surfaces of two adjacent discharging rollers increase sequentially from top to bottom.

Preferably, upper and lower two rows of transmission rods rotating in opposite directions are arranged at two ends of the pickling box, and one ends of two of the transmission rods are each provided with a connecting gear for changing the rotation direction of the corresponding transmission rod, and the connecting gears are meshed with each other.

Side walls of the cooling box and the pickling box are both connected with an installation box. The interior of the installation box is rotatably connected with a main gear, and the connecting gear is meshed with the main gear. One end of the main gear is connected with a driving motor.

Chain wheels are fixedly connected to side walls of the transmission rod and the discharging roller, and a chain belt is sleeved between the chain wheels.

Preferably, a plurality of hydraulic rods are installed on the side wall of the cooling box. One end of the hydraulic rod is connected with a top plate for pushing the oxygen-free copper alloy plate to move upward and a push plate for pushing the oxygen-free copper alloy plate into the interior of the pickling box.

A limiting block with a triangular side wall is installed on an inner side wall of the cooling box, and the limiting block abuts against the side wall of the oxygen-free copper alloy plate.

Preferably, the pumping mechanism includes a high-pressure water pump and an air pump. The high-pressure water pump and the air pump are installed on the surface of the cooling box. The high-pressure water pump is connected to the cooling box and the pickling box through a water pipe. A bottom end of the water pipe is communicated with a steel pipe, and the steel pipe is vertically connected with a floating plate.

Preferably, the air pump rapidly draws the gas inside the cooling box into the interior of the pickling pipe through an air supply pipe. Funnel-shaped mixing plates are symmetrically installed inside the pickling pipe, and a stop block is installed between the two mixing plates.

One end of the pickling box is provided with a flushing pipe. The flushing pipe is communicated with the water pipe inside the pickling box. A plurality of flushing nozzles are installed at a bottom end of the flushing pipe.

Preferably, the polishing mechanism includes fixed shafts and box bodies. I-shaped box bodies are symmetrically installed on the surface of the pickling box. The interior of each box body is rotatably connected with a first gear and a second gear that are meshed with each other. The first gear is connected to the driving motor, and the diameter of the first gear is larger than that of the second gear.

Top ends of the first gear, the second gear, and the fixed shaft are fixedly connected to the chain wheels.

Bottom ends of the fixed shafts are respectively fixedly connected to a first grinding wheel and a second grinding wheel, and the first grinding wheel and the second grinding wheel are arranged in a staggered manner.

Preferably, between the adjacent cleaning mechanism and the scouring mechanism, rotation directions of the first grinding wheel and the second grinding wheel are opposite. Top ends of four of the fixed shafts are fixedly connected with a third gear for changing the rotation directions of the first grinding wheel and the second grinding wheel, and adjacent third gears are meshed with each other.

Preferably, the scouring mechanism includes cylinders. A plurality of cylinders are fixedly connected to an inner side wall of the pickling box. A middle part of a side wall of each cylinder is communicated with the water pipe inside the pickling box through a connecting pipe.

A turbine is rotatably connected inside the cylinder. The chain wheel on a side wall of the turbine is connected with the chain wheel on a side wall of a speed-increasing gear through the chain belt. The speed-increasing gear is meshed with the main gear, and the diameter of the speed-increasing gear is smaller than that of the main gear.

The side wall of the cylinder is communicated with a high-pressure nozzle for removing the oxide layer on the side wall of the oxygen-free copper alloy plate. Partition plates with arc-shaped side walls are installed at upper and lower ends of the high-pressure nozzle, and the oxygen-free copper alloy plate is slidably connected between the partition plates.

A processing method specifically includes the following steps:
step 1: placing high-purity cathode copper in a vacuum induction furnace for smelting, before smelting, vacuumizing for preheating and drying the high-purity cathode copper, using charcoal subjected to drying treatment as a covering agent, and introducing inert gas at the bottom of the induction furnace, performing smelting at 1150-1200° C., where during a smelting process, the inert gas makes the gas in copper liquid in the furnace enter inert gas bubbles, as the bubbles float to a surface of the copper liquid, the gas reacts with the charcoal covering inside the furnace to generate CO for removal; after complete melting, adding a rare earth purifying agent and a composite deoxidizer, adding magnesium and tin into the furnace, continuing stirring for 2-5 min, and standing for 20-30 min to obtain an oxygen-free copper alloy melt; pouring the oxygen-free copper alloy melt into a preheated mold to obtain an oxygen-free copper alloy ingot; proportions of the raw materials in parts by weight are: 100 parts of the high-purity cathode copper, 0.02-0.1 parts of the rare earth purifying agent, 0.1-0.5 parts of the composite deoxidizer, 0.004-0.008 parts of magnesium, and 0.005-0.01 parts of tin;
step 2: under the condition of 800-860° C., performing hot rolling on the oxygen-free copper alloy ingot to prepare an oxygen-free copper alloy plate, connecting the equipment to an external power supply, placing the hot-rolled oxygen-free copper alloy plate on the surface of the sliding cylinder, and placing the oxygen-free copper alloy plate cooled inside the cooling box into the pickling box; placing the oxygen-free copper alloy plate inside the cooling box, where operation of the relief mechanism makes water flow rapidly along the surface of the oxygen-free copper alloy plate, accelerating the heat dissipation efficiency, quickly carrying away the temperature of the oxygen-free copper alloy plate and the surrounding gas, and reducing the oxidation efficiency;
step 3: when the oxygen-free copper alloy plate moves inside the pickling box, the oxygen-free copper alloy plate slides over the side wall of the rubber pad, in this case, acid liquid mixes with the gas inside the cooling box and enters the interior of the rubber pad; the acid liquid contacts the surface of the oxygen-free copper alloy plate inside the rubber pad and the acid liquid reacts with the oxide layer, since the acid liquid contains a large number of bubbles, the bubbles churn inside the rubber pad to constantly push the acid liquid to contact the oxide layer, the gas generated during cooling of the oxygen-free copper alloy plate is used for driving the flow of the acid liquid, accelerating the reaction rate between the oxide layer and the acid liquid, and the acid liquid flows through the compression rod and the lever, causing the rubber pad to move up and down continuously; when the elastic rubber pad moves downward, certain distance is spread on the surface of the oxygen-free copper alloy plate, increasing a cleaning range of the acid liquid, at the same time, continuous contraction and spreading of the rubber pad push the acid liquid to move up and down continuously, enabling the acid liquid to constantly contact the surface of the oxygen-free copper alloy plate, further improving the reaction efficiency between the oxide layer and the acid liquid;
step 4: the pickled oxygen-free copper alloy plate contacts the rotating polishing mechanism for oxide layer removal, so that the oxide layer on the surface of the oxygen-free copper alloy plate is removed, the oxygen-free copper alloy plate continues to move and contacts the scouring mechanism to remove the oxide layer on the side wall of the oxygen-free copper alloy plate and clean the surface of the oxygen-free copper alloy plate; after being cleaned by the high-pressure nozzle, the oxygen-free copper alloy plate undergoes pickling, polishing, and scouring again to further removal of the oxide layer, then, the water sprayed from the flushing nozzle is used for thoroughly cleaning the oxygen-free copper alloy plate; repeating the above operations to cool the oxygen-free copper alloy plate inside the cooling box and the pickling box and remove the oxide layer; and
step 5: after thoroughly cleaning and drying the oxygen-free copper alloy plate, performing pre-finish rolling and then sending the oxygen-free copper alloy plate into an annealing furnace for annealing treatment, placing the oxygen-free copper alloy plate taken out of the annealing furnace into the cooling box and the pickling box again to remove the oxide layer, and finally, after finish rolling the oxygen-free copper alloy plate, the oxygen-free copper alloy thick strip is obtained.

Compared with the prior art, the beneficial effects of the present invention are:

When the oxygen-free copper alloy plate enters the cooling box, the oxygen-free copper alloy plate moves to a position above the nozzles. In this case, the water sprayed by the nozzles rushes toward the bottom surface of the oxygen-free copper alloy plate. The inclination angles of the nozzles gradually increase from the center of the conveying pipe to the end of the conveying pipe, so that the water sprayed by the nozzles pushes the water on the bottom surface of the oxygen-free copper alloy plate to move toward the edge of the oxygen-free copper alloy plate. The water sprayed by the turning nozzles is obliquely upward toward the edge of the oxygen-free copper alloy plate, thereby pushing the water at the edge of the oxygen-free copper alloy plate to move upward.

The downward pressure nozzles spray water obliquely downward, and the distances between adjacent downward pressure nozzles and the inclination angles of the downward pressure nozzles gradually increase from the end of the conveying pipe to the center of the conveying pipe, so that the water sprayed by the downward pressure nozzles pushes the water moving upward from the edge of the oxygen-free copper alloy plate toward the center of the top surface of the oxygen-free copper alloy plate. When the oxygen-free copper alloy plate is cooled, the water flows rapidly along the surface of the oxygen-free copper alloy plate, accelerating the heat dissipation efficiency and quickly carrying away the gas generated by the high temperature of the oxygen-free copper alloy plate. The flowing low-temperature water constantly contacts the surface of the oxygen-free copper alloy plate, preventing the oxygen-free copper alloy plate from rapid oxidation in the water and reducing the oxidation efficiency. The water and gas generated during the cooling of the oxygen-free copper alloy plate are delivered into the pickling box by the pumping mechanism. In this case, the oxygen-free copper alloy plate moves inside the pickling box for oxide layer removal. The gas and the acid liquid are mixed and enter the interior of the rubber pad through the connecting pipe, the joint, the support rod, and the sliding rod. The rubber pad is in contact with the oxygen-free copper alloy plate, and the acid liquid inside the rubber pad contacts the surface of the oxygen-free copper alloy plate and reacts with the oxide layer. Moreover, since the acid liquid contains a large number of bubbles, the bubbles churn inside the rubber pad to push the acid liquid to continuously contact the oxide layer and accelerate the reaction rate between the oxide layer and the acid liquid. When the acid liquid is sprayed out from the interior of the connecting pipe, the acid liquid contacts the rotating shaft and the compression rod. The rotation of the compression rod drives the lever to rotate. The end of the lever far away from the support is in contact with the compression rod, and the end of the lever close to the support is in contact with the piston, reducing the resistance when the compression rod pushes the lever to rotate. By using the lever principle, the rotation of the lever pushes the sliding rod and the pressing plate to move downward to squeeze the spring and the rubber pad. After being squeezed by the pressing plate, the rubber pad approaches the oxygen-free copper alloy plate. When the compression rod rotates and separates from the lever, the spring pushes the sliding rod and the lever to return to their original positions. As the compression rod rotates, the rubber pad continuously spreads and contracts on the surface of the oxygen-free copper alloy plate. The elastic rubber pad spreads certain distance on the surface of the oxygen-free copper alloy plate, increasing the cleaning range of the acid liquid. Meanwhile, the continuous contraction and spreading of the rubber pad push the acid liquid to move up and down continuously, enabling the acid liquid to constantly contact the surface of the oxygen-free copper alloy plate, further increasing the reaction rate between the oxide layer and the acid liquid and accelerating the cleaning efficiency of the oxide layer on the surface of the oxygen-free copper alloy plate.

### BRIEF DESCRIPTION OF DRAWINGS

FIG. 1 is a schematic structural diagram of a preferred embodiment of the present invention;

FIG. 2 is a side view of an internal structure of a cooling box in FIG. 1;

FIG. 3 is a schematic diagram of an internal structure of a pickling box shown in FIG. 1;

FIG. 4 is a top view of the internal structure of the pickling box shown in FIG. 3;

FIG. 5 is a schematic diagram of an internal structure of a pickling pipe shown in FIG. 3;

FIG. 6 is a schematic structural diagram of a scouring mechanism and an oxygen-free copper alloy plate shown in FIG. 3;

FIG. 7 is a top view of the structure of the cooling box shown in FIG. 1;

FIG. 8 is a schematic structural diagram of a chain wheel shown in FIG. 4;

FIG. 9 is a top view of an internal structure of a box body shown in FIG. 3;

FIG. 10 is an enlarged schematic diagram of a structure at point A shown in FIG. 1;

FIG. 11 is an enlarged schematic diagram of a structure at point B shown in FIG. 1;

FIG. 12 is an enlarged schematic diagram of a structure at point C shown in FIG. 3; and

FIG. 13 is a schematic diagram of a cooling process of an oxygen-free copper alloy plate provided by the present invention.

In the figures: 1. Cooling box, 11. Hydraulic rod, 12. Push plate, 13. Top plate, 14. Limiting block, 2. Transmission mechanism, 21. Transmission rod, 22. Sliding cylinder, 23. Driving motor, 24. Chain wheel, 25. Chain belt, 26. Installation box, 27. Main gear, 28. Connecting gear, 29. Discharging roller, 210. Protrusion, 3. Oxygen-free copper alloy plate, 4. Pickling box, 41. Pickling pipe, 42. Flushing nozzle, 43. Flushing pipe, 44. Mixing plate, 45. Stop block, 5. Relief mechanism, 51. Conveying pipe, 52. Nozzle, 53. Turning nozzle, 54. Downward pressure nozzle, 55. Baffle plate, 6. Pumping mechanism, 61. Floating plate, 62. Steel pipe, 63. High-pressure water pump, 64. Air pump, 65. Air supply pipe, 66. Water pipe, 7. Scouring mechanism, 71. Cylinder, 72. Turbine, 73. Connecting pipe, 74. High-pressure nozzle, 75. Partition plate, 76. Speed-increasing gear, 8. Cleaning mechanism, 81. Rubber pad, 82. Pressing plate, 83. Sliding rod, 84. Spring, 85. Piston, 86. Support, 87. Lever, 88. Support rod, 89. Joint, 810. Communicating pipe, 811. Rotating shaft, 812. Compression rod, 9. Polishing mechanism, 91. Fixed shaft, 92. First grinding wheel, 93. Second grinding wheel, 94. Box body, 95. First gear, 96. Second gear, and 97. Third gear.

### DETAILED DESCRIPTION OF THE EMBODIMENTS

The following will clearly and completely describe the technical solutions in the embodiments of the present invention with reference to the accompanying drawings in the embodiments of the present invention. Obviously, the described embodiments are only a part of the embodiments of the present invention, not all of the embodiments. All other embodiments obtained by those of ordinary skill in the art without creative work based on the embodiments of the present invention shall fall within the protection scope of the present invention.

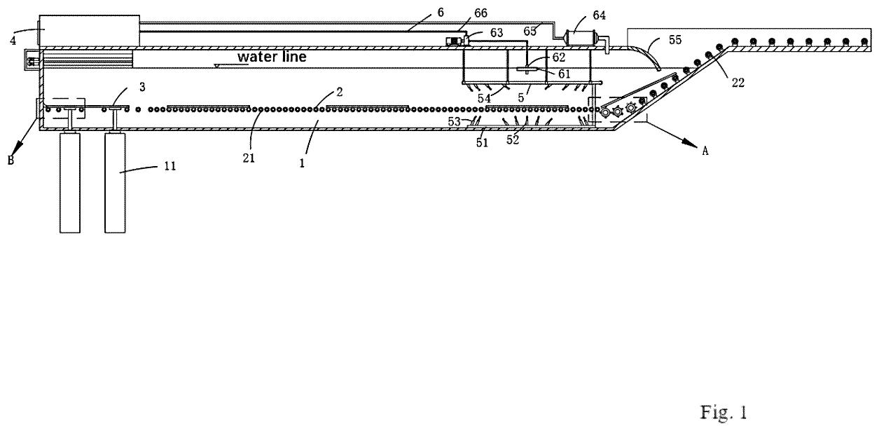

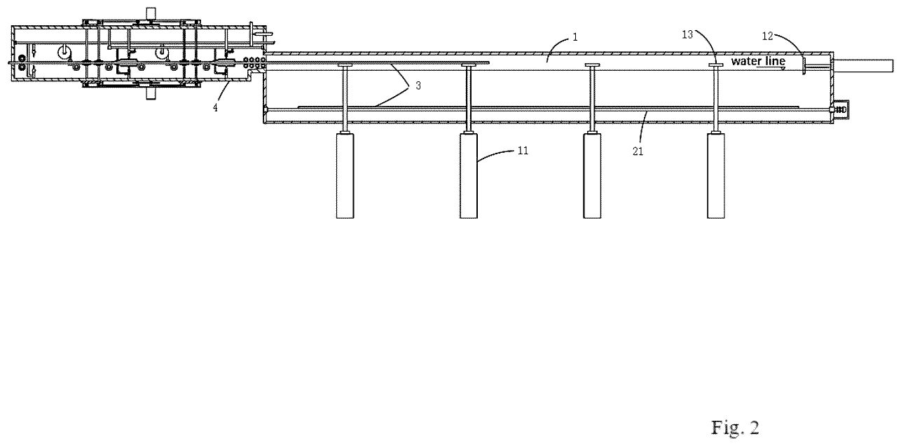

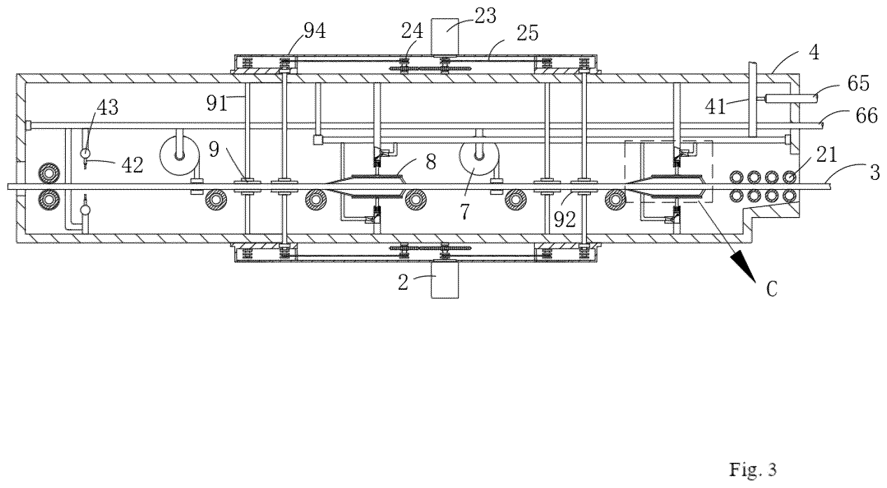

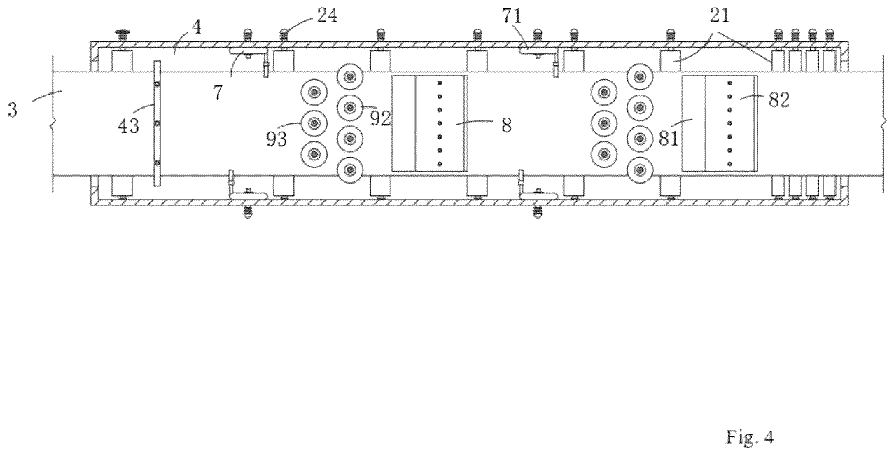

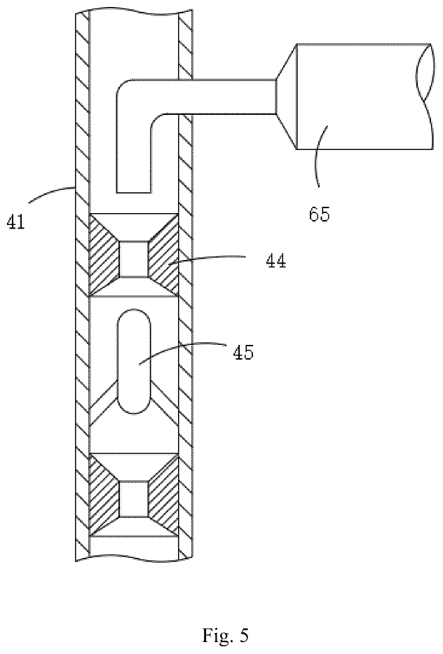

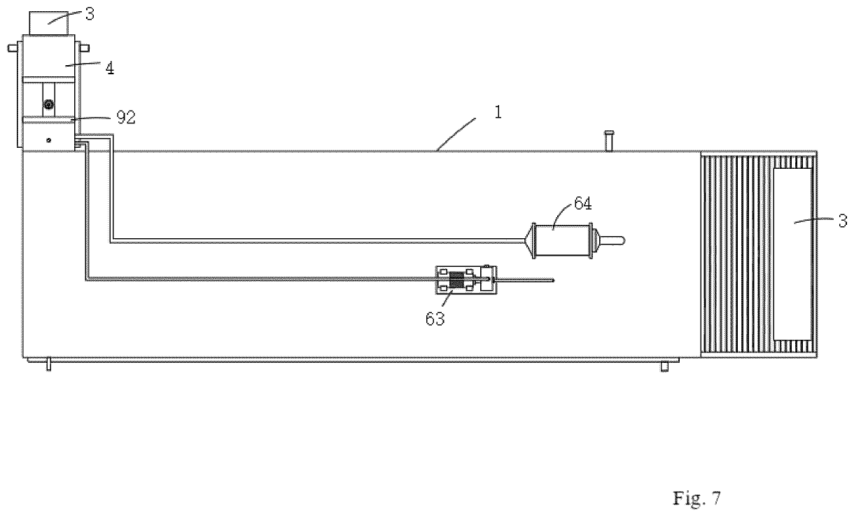

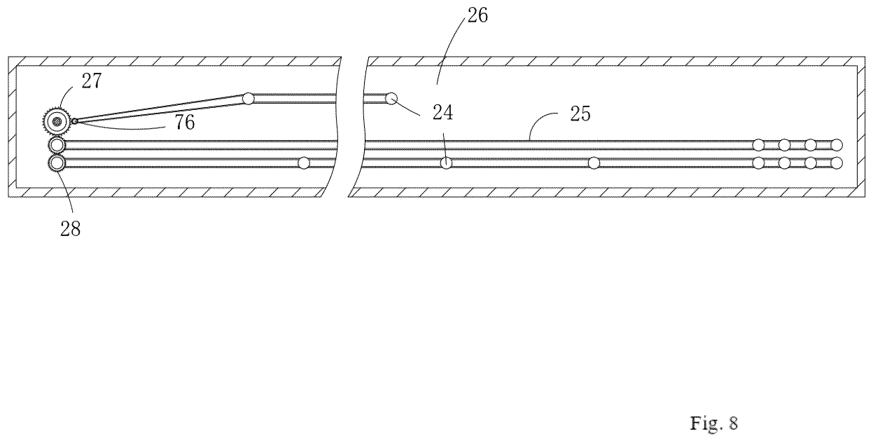

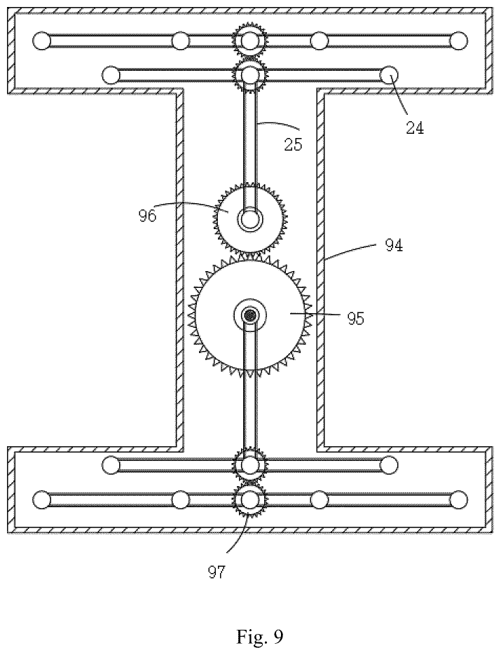

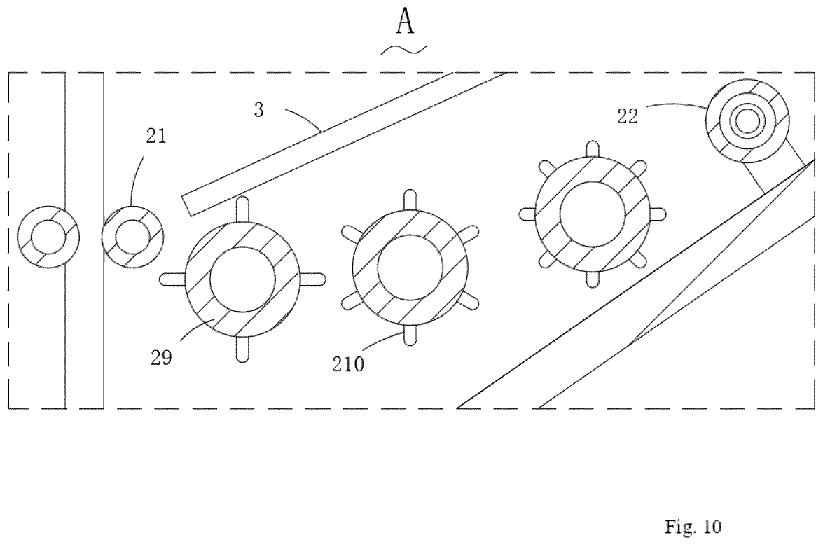

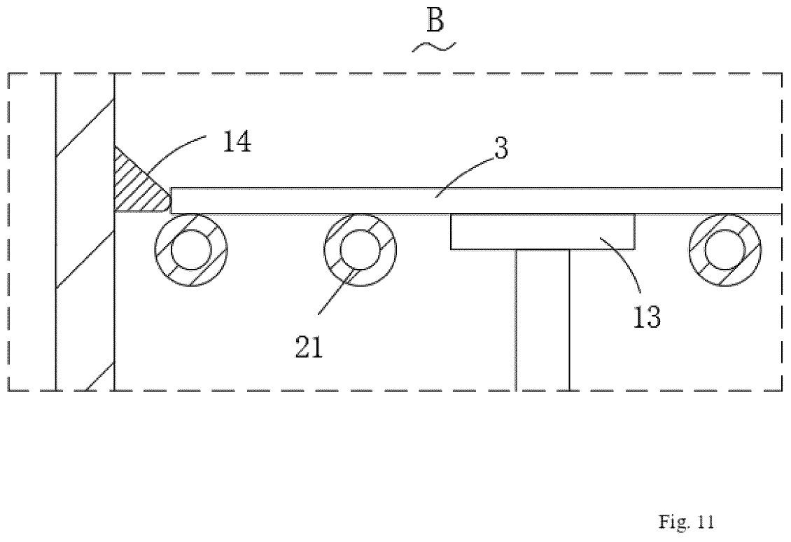

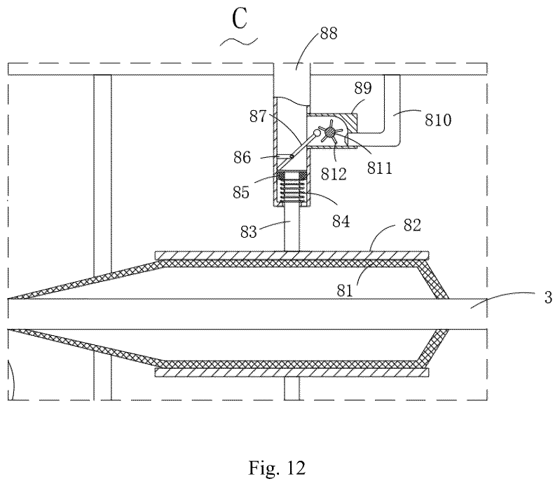

Referring to FIG. 1 to FIG. 13, the present invention provides a technical solution: production and processing equipment for oxygen-free copper alloy thick strips, which includes a cooling box 1 and a pickling box 4. Both the cooling box 1 and the pickling box 4 are internally provided with a transmission mechanism 2 for driving the movement of an oxygen-free copper alloy plate 3, and the cooling box 1 is internally provided with a relief mechanism 5 for rapidly cooling the oxygen-free copper alloy plate 3 and reducing the thickness of an oxide layer.

In this embodiment, the transmission mechanism 2 includes a transmission rod 21 and a sliding cylinder 22. The transmission rod 21 is located at a tail end of the sliding cylinder 22 and extends to a tail end of the cooling box 1. The sliding cylinder 22 is arranged at an entrance of the cooling box 1. A plurality of discharging rollers 29 are provided at a transition position between the transmission rod 21 and the sliding cylinder 22. A plurality of protrusions 210 are installed on a side wall of the discharging roller 29, and lengths of the protrusions 210 on surfaces of two adjacent discharging rollers 29 increase sequentially from top to bottom. When the oxygen-free copper alloy plate 3 subjected to hot rolling and annealing is placed on a surface of the sliding cylinder 22, the oxygen-free copper alloy plate 3 moves downward along the sliding cylinder 22 and contacts the discharging roller 29. The discharging roller 29 and the protrusions 210 rotate continuously. The rotation of the discharging roller 29 pushes the oxygen-free copper alloy plate 3 to move toward the interior of the cooling box 1, and the protrusions 210 on the side wall of the discharging roller 29 intermittently squeeze the oxygen-free copper alloy plate 3 upward, making the oxygen-free copper alloy plate 3 vibrate continuously on the surfaces of the sliding cylinder 22 and the discharging roller 29, which is conducive to the downward movement of the oxygen-free copper alloy plate 3 to a surface of the transmission rod 21. The lengths of the protrusions 210 on the surfaces of two adjacent discharging rollers 29 gradually increase from top to bottom. As the oxygen-free copper alloy plate 3 moves downward, the vibration amplitude of the oxygen-free copper alloy plate 3 becomes larger and larger, which is conducive to the protrusions 210 pushing the oxygen-free copper alloy plate 3 to the surface of the transmission rod 21, so that the transmission rod 21 pushes the oxygen-free copper alloy plate 3 to move inside the cooling box 1.

The relief mechanism 5 includes conveying pipes 51 and a baffle plate 55. The baffle plate 55 with an arc-shaped edge is installed inside the top of the cooling box 1, and the conveying pipes 51 are symmetrically installed on upper and lower sides of the transmission mechanism 2 inside the cooling box 1.

A plurality of nozzles 52 and turning nozzles 53 are installed on an upper side of the conveying pipe 51 located at the lower side of the transmission mechanism 2, and a plurality of downward pressure nozzles 54 are installed at a bottom end of the conveying pipe 51 located at the upper side of the transmission mechanism 2.

Inclination angles of the nozzles 52 increase sequentially from a middle position of the conveying pipe 51 to an edge position of the conveying pipe 51. The turning nozzles 53 are obliquely fixed at two ends of the conveying pipe 51 and are located outside the nozzles 52.

In this embodiment, distances between adjacent downward pressure nozzles 54 and inclination angles of the downward pressure nozzles 54 gradually increase from an edge position of the conveying pipe 51 to a middle position of the conveying pipe 51.

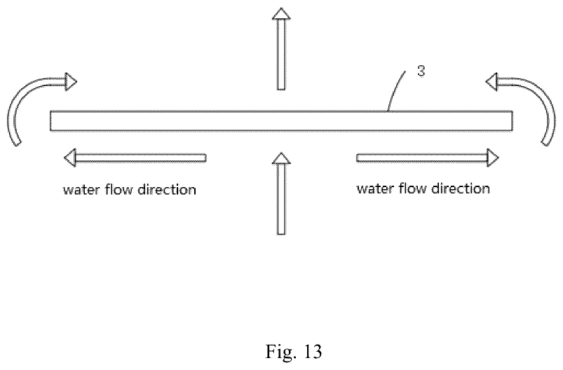

In this embodiment, the transmission rod 21 drives the oxygen-free copper alloy plate 3 to move to a position above the nozzles 52, as shown in FIG. 1. In this case, the conveying pipe 51 is externally connected to a water pump, so that the nozzles 52 spray water toward a bottom surface of the oxygen-free copper alloy plate 3. The inclination angles of the nozzles 52 gradually increase from the center of the conveying pipe 51 to the end of the conveying pipe 51, so that the water sprayed by the nozzles 52 pushes the water on the bottom surface of the oxygen-free copper alloy plate 3 to move toward the edge of the oxygen-free copper alloy plate 3. The water sprayed by the turning nozzles 53 is obliquely upward toward the edge of the oxygen-free copper alloy plate 3, thereby promoting the upward movement of the water at the edge of the oxygen-free copper alloy plate 3. The downward pressure nozzles 54 spray water obliquely downward, and the distances between adjacent downward pressure nozzles 54 and the inclination angles of the downward pressure nozzles 54 gradually increase from the end of the conveying pipe 51 to the center of the conveying pipe 51, so that the water sprayed by the downward pressure nozzles 54 pushes the water moving upward from the edge of the oxygen-free copper alloy plate 3 toward the center of the top surface of the oxygen-free copper alloy plate 3. When the oxygen-free copper alloy plate 3 is cooled, the water flows rapidly along the surface of the oxygen-free copper alloy plate 3, as shown in FIG. 13, accelerating the heat dissipation efficiency and quickly carrying away the gas generated by the high temperature of the oxygen-free copper alloy plate 3. The flowing low-temperature water constantly contacts the surface of the oxygen-free copper alloy plate 3, preventing the oxygen-free copper alloy plate 3 from rapid oxidation in the water and reducing the oxidation efficiency.

The cooling box 1 is internally provided with a pumping mechanism 6 for delivering water and gas to the interior of the pickling box 4, and the pickling box 4 is internally provided with a cleaning mechanism 8 for performing pickling treatment on the oxide layer.

The cleaning mechanism 8 includes support rods 88. A plurality of support rods 88 are installed inside the pickling box 4, and the support rods 88 are connected to a communicating pipe 810 through joints 89. The interior of each joint 89 is rotatably connected with a rotating shaft 811 and compression rods 812, enabling the rotating shaft 811 to rotate freely within the joint 89. A side wall of the rotating shaft 811 is fixedly connected with a plurality of compression rods 812.

A lever 87 is rotatably connected inside each joint 89 and the corresponding support rod 88, and a spherical end of the lever 87 abuts against a lower side of the compression rod 812.

A piston 85 and a sliding rod 83 are slidably connected inside the support rod 88, and a top end of the sliding rod 83 is sleeved inside the piston 85.

A bottom end of the lever 87 abuts against the top of the piston 85, and the lever 87 is installed on an inner side wall of the support rod 88 through a support 86.

A spring 84 sleeves a side wall of the sliding rod 83, and two ends of the spring 84 respectively abut against a bottom surface of the piston 85 and a bottom sealing surface of the support rod 88.

A bottom end of the sliding rod 83 is fixedly connected to a pressing plate 82, and rubber pads 81 are installed on a side wall of the pressing plate 82. A plurality of rubber pads 81 are slidably connected to a top surface and a bottom surface of the oxygen-free copper alloy plate 3.

In this embodiment, when removing the oxide layer, the oxygen-free copper alloy plate 3 slides on the surface of the rubber pad 81. The mixed gas and acid liquid enter the interior of the rubber pad 81 through the communicating pipe 810, the joint 89, the support rod 88, and the sliding rod 83. The rubber pad 81 is in contact with the oxygen-free copper alloy plate 3, and the acid liquid inside the rubber pad 81 contacts the surface of the oxygen-free copper alloy plate 3 and reacts with the oxide layer. Moreover, since the acid liquid contains a large number of bubbles, the bubbles churn inside the rubber pad 81 to push the acid liquid to continuously contact the oxide layer and accelerate the reaction rate between the oxide layer and the acid liquid. When the acid liquid is sprayed out from the interior of the communicating pipe 810, the acid liquid contacts the rotating shaft 811 and the compression rod 812. The rotation of the compression rod 812 drives the lever 87 to rotate. The end of the lever 87 far away from the support 86 is in contact with the compression rod 812, and the end of the lever 87 close to the support 86 is in contact with the piston 85, reducing the resistance when the compression rod 812 pushes the lever 87 to rotate. By using the lever principle, the rotation of the lever 87 pushes the sliding rod 83 and the pressing plate 82 to move downward to squeeze the spring 84 and the rubber pad 81. After being squeezed by the pressing plate 82, the rubber pad 81 approaches the oxygen-free copper alloy plate 3. When the compression rod 812 rotates and separates from the lever 87, the spring 84 pushes the sliding rod 83 and the lever 87 to return to their original positions. As the compression rod 812 rotates, the rubber pad 81 continuously spreads and contracts on the surface of the oxygen-free copper alloy plate 3. The elastic rubber pad 81 spreads certain distance on the surface of the oxygen-free copper alloy plate 3, increasing the cleaning range of the acid liquid. Meanwhile, the continuous contraction and spreading of the rubber pad 81 push the acid liquid to move up and down continuously, enabling the acid liquid to constantly contact the surface of the oxygen-free copper alloy plate 3, further increasing the reaction rate between the oxide layer and the acid liquid and accelerating the cleaning efficiency of the oxide layer on the surface of the oxygen-free copper alloy plate 3.

The pickling box 4 is internally provided with a polishing mechanism 9 for removing the oxide layer on the surface of the oxygen-free copper alloy plate 3, and two ends of the pickling box 4 are provided with scouring mechanisms 7 for removing the oxide layer at edges of side walls of the oxygen-free copper alloy plate 3.

In this embodiment, upper and lower two rows of transmission rods 21 rotating in opposite directions are arranged at two ends of the pickling box 4, and one ends of two of the transmission rods 21 are each provided with a connecting gear 28 for changing the rotation direction of the corresponding transmission rod 21, and the connecting gears 28 are meshed with each other.

Side walls of the cooling box 1 and the pickling box 4 are both connected with an installation box 26. The interior of the installation box 26 is rotatably connected with a main gear 27, and the connecting gear 28 is meshed with the main gear 27. One end of the main gear 27 is connected with a driving motor 23.

Chain wheels 24 are fixedly connected to side walls of the transmission rod 21 and the discharging roller 29, and a chain belt 25 is sleeved between the chain wheels 24.

The chain wheels 24 are fixedly connected to the side walls of the transmission rod 21 and the discharging roller 29, and the chain belt 25 is sleeved between the chain wheels 24. To facilitate the driving motor 23 to drive the main gear 27 to rotate during operation, the main gear 27 drives the connecting gear 28 to rotate, and the connecting gear 28 drives the transmission rod 21 and the discharging roller 29 to rotate through the chain belt 25 and the chain wheel 24, so that the transmission rod 21 and the discharging roller 29 can push the oxygen-free copper alloy plate 3 to move.

In this embodiment, a plurality of hydraulic rods 11 are installed on the side wall of the cooling box 1, and one end of the hydraulic rod 11 is connected with a top plate 13 for pushing the oxygen-free copper alloy plate 3 to move upward and a push plate 12 for pushing the oxygen-free copper alloy plate 3 into the interior of the pickling box 4.

A limiting block 14 with a triangular side wall is installed on an inner side wall of the cooling box 1, and the limiting block 14 abuts against the side wall of the oxygen-free copper alloy plate 3, so as to facilitate the limiting block 14 to neatly fix the oxygen-free copper alloy plate 3 inside one end of the cooling box 1, and to facilitate the hydraulic rod 11 to drive the top plate 13 to move and lift the oxygen-free copper alloy plate 3, and the push plate 12 to move and push the oxygen-free copper alloy plate 3 into the interior of the pickling box 4.

In this embodiment, the pumping mechanism 6 includes a high-pressure water pump 63 and an air pump 64. The high-pressure water pump 63 and the air pump 64 are installed on the surface of the cooling box 1. The high-pressure water pump 63 is connected to the cooling box 1 and the pickling box 4 through a water pipe 66. A bottom end of the water pipe 66 is communicated with a steel pipe 62, and the steel pipe 62 is vertically connected with a floating plate 61. During the cooling process of the oxygen-free copper alloy plate 3, the temperature of the water inside the cooling box 1 rises. The floating plate 61 carries the steel pipe 62 to float on the water surface, and one end of the steel pipe 62 penetrates through the floating plate 61 and extends into the water, which is convenient for the high-pressure water pump 63 to pump out the water inside the cooling box 1 through the water pipe 66 and the steel pipe 62, and the relief mechanism 5 continuously supplies low-temperature water to the cooling box 1 to maintain the water level and water temperature inside the cooling box 1.

In this embodiment, one end of the pickling box 4 is provided with a flushing pipe 43, and the flushing pipe 43 is communicated with the water pipe 66 inside the pickling box 4. A plurality of flushing nozzles 42 are installed at a bottom end of the flushing pipe 43. The air pump 64 rapidly draws the gas inside the cooling box 1 into the interior of the pickling pipe 41 through an air supply pipe 65. Funnel-shaped mixing plates 44 are symmetrically installed inside the pickling pipe 41, and a stop block 45 is installed between the two mixing plates 44. One end of the pickling box 4 is provided with the flushing pipe 43, and the flushing pipe 43 is communicated with the water pipe 66 inside the pickling box 4. A plurality of flushing nozzles 42 are installed at the bottom end of the flushing pipe 43 to facilitate the flushing nozzles 42 to clean the surface of the oxygen-free copper alloy plate 3. The gas inside the cooling box 1 is sent into the pickling pipe 41 to be mixed with the acid liquid, and then passes through the internally funnel-shaped mixing plates 44 to primarily mix the gas and the acid liquid. After the primary mixing, the gas and the acid liquid slide over a side wall of the stop block 45, causing the gas and the acid liquid to move toward the inner side wall of the pickling pipe 41, thereby remixing the gas and the acid liquid. The mixed gas and acid liquid then pass through the internally funnel-shaped mixing plates 44, so that the gas and the acid liquid are more uniformly mixed after multiple mixing processes.

In this embodiment, the polishing mechanism 9 includes fixed shafts 91 and box bodies 94. I-shaped box bodies 94 are symmetrically installed on the surface of the pickling box 4. The interior of each box body 94 is rotatably connected with a first gear 95 and a second gear 96 that are meshed with each other. The first gear 95 is connected to the driving motor 23, and the diameter of the first gear 95 is larger than that of the second gear 96.

Top ends of the first gear 95, the second gear 96, and the fixed shaft 91 are fixedly connected to the chain wheels 24.

Bottom ends of the fixed shafts 91 are respectively fixedly connected to a first grinding wheel 92 and a second grinding wheel 93, and the first grinding wheel 92 and the second grinding wheel 93 are arranged in a staggered manner.

When the driving motor 23 rotates, the first gear 95 and the second gear 96 are driven to rotate, thereby driving all the fixed shafts 91, the first grinding wheel 92, and the second grinding wheel 93 to rotate. The first grinding wheel 92 and the second grinding wheel 93 rotate to polish the surface of the oxygen-free copper alloy plate 3. The first grinding wheel 92 and the second grinding wheel 93 are arranged in a staggered manner, so that the first grinding wheel 92 and the second grinding wheel 93 can uniformly polish the surface of the oxygen-free copper alloy plate 3, avoiding the situation where the oxide layer on the surface of the oxygen-free copper alloy plate 3 is not polished and removed. After primary pickling, the oxygen-free copper alloy plate 3 contacts the first set of rotating grinding wheels. After secondary pickling, the oxygen-free copper alloy plate 3 contacts the second set of rotating grinding wheels. The diameter of the first gear 95 is larger than that of the second gear 96, so the rotation speed of the second set of grinding wheels is greater than that of the first set of grinding wheels, which increases the friction force of the grinding wheels on the surface of the oxygen-free copper alloy plate 3 and effectively removes the oxide layer.

In this embodiment, between the adjacent cleaning mechanism 8 and the scouring mechanism 7, the rotation directions of the first grinding wheel 92 and the second grinding wheel 93 are opposite. Top ends of four of the fixed shafts 91 are fixedly connected with a third gear 97 for changing the rotation directions of the first grinding wheel 92 and the second grinding wheel 93, and adjacent third gears 97 are meshed with each other. During the polishing process of the oxygen-free copper alloy plate 3, the first grinding wheel 92 and the second grinding wheel 93 clean the oxide layer on the surface of the oxygen-free copper alloy plate 3 from different directions, improving the cleaning effect.

In this embodiment, the scouring mechanism 7 includes cylinders 71. A plurality of cylinders 71 are fixedly connected to an inner side wall of the pickling box 4. A middle part of a side wall of each cylinder 71 is communicated with the water pipe 66 inside the pickling box 4 through a connecting pipe 73.

A turbine 72 is rotatably connected inside the cylinder 71. The chain wheel 24 on a side wall of the turbine 72 is connected with the chain wheel 24 on a side wall of a speed-increasing gear 76 through the chain belt 25. The speed-increasing gear 76 is meshed with the main gear 27, and the diameter of the speed-increasing gear 76 is smaller than that of the main gear 27.

The side wall of the cylinder 71 is communicated with a high-pressure nozzle 74 for removing the oxide layer on the side wall of the oxygen-free copper alloy plate 3. Partition plates 75 with arc-shaped side walls are installed at upper and lower ends of the high-pressure nozzle 74, and the oxygen-free copper alloy plate 3 is slidably connected between the partition plates 75.

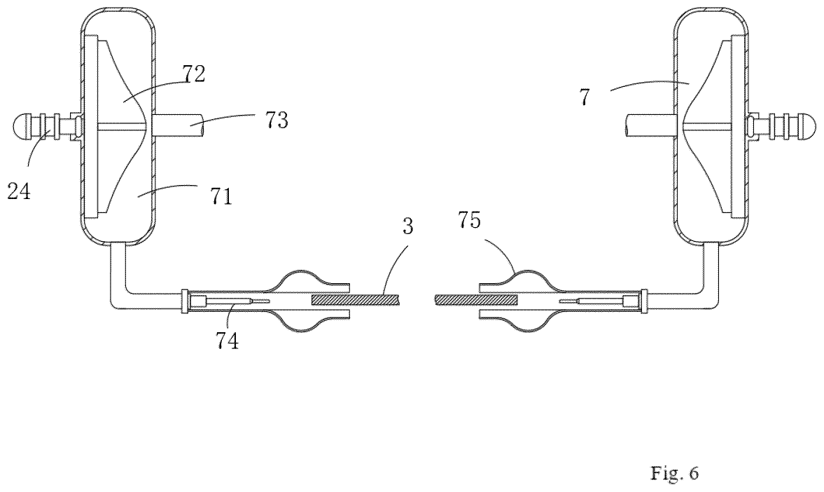

The water pumped by the high-pressure water pump 63 enters the interior of the cylinder 71 through the water pipe 66 and the connecting pipe 73. Since the diameter of the speed-increasing gear 76 is much smaller than that of the main gear 27, the turbine 72 rotates rapidly inside the cylinder 71. The water is accelerated by the turbine 72 and then sprayed onto the side wall of the oxygen-free copper alloy plate 3 through the high-pressure nozzle 74, as shown in FIG. 6. The high-pressure water washes away the oxide layer on the side wall of the oxygen-free copper alloy plate 3, and the part of the water contacting the side wall of the oxygen-free copper alloy plate 3 moves along the partition plates 75, causing the water to continue to rush toward the surface of the oxygen-free copper alloy plate 3 through the partition plates 75, thereby cleaning the surface of the oxygen-free copper alloy plate 3.

A production and processing method for oxygen-free copper alloy thick strips specifically includes the following steps:
step 1: high-purity cathode copper is placed in a vacuum induction furnace for smelting, before smelting, vacuumizing is performed for preheating and drying the high-purity cathode copper, charcoal subjected to drying treatment is used as a covering agent, and inert gas is introduced at the bottom of the induction furnace, smelting is performed at 1150-1200° C., where during a smelting process, the inert gas makes the gas in copper liquid in the furnace enter inert gas bubbles, as the bubbles float to a surface of the copper liquid, the gas reacts with the charcoal covering inside the furnace to generate CO for removal; after complete melting, a rare earth purifying agent and a composite deoxidizer are added, magnesium and tin are added into the furnace, stirring is continued for 2-5 min, and standing is performed for 20-30 min to obtain an oxygen-free copper alloy melt; the oxygen-free copper alloy melt is poured into a preheated mold to obtain an oxygen-free copper alloy ingot; proportions of the raw materials in parts by weight are: 100 parts of the high-purity cathode copper, 0.02-0.1 parts of the rare earth purifying agent, 0.1-0.5 parts of the composite deoxidizer, 0.004-0.008 parts of magnesium, and 0.005-0.01 parts of tin;
step 2: under the condition of 800-860° C., hot rolling is performed on the oxygen-free copper alloy ingot to prepare an oxygen-free copper alloy plate 3, the equipment is connected to an external power supply, the hot-rolled oxygen-free copper alloy plate 3 is placed on the surface of the sliding cylinder 22, and the oxygen-free copper alloy plate 3 cooled inside the cooling box 1 is placed into the pickling box 4; the oxygen-free copper alloy plate 3 is placed inside the cooling box 1, where operation of the relief mechanism 5 makes water flow rapidly along the surface of the oxygen-free copper alloy plate 3, accelerating the heat dissipation efficiency, quickly carrying away the temperature of the oxygen-free copper alloy plate 3 and the surrounding gas, and reducing the oxidation efficiency;
step 3: when the oxygen-free copper alloy plate 3 moves inside the pickling box 4, the oxygen-free copper alloy plate 3 slides over the side wall of the rubber pad 81, in this case, acid liquid mixes with the gas inside the cooling box 1 and enters the interior of the rubber pad 81; the acid liquid contacts the surface of the oxygen-free copper alloy plate 3 inside the rubber pad 81 and the acid liquid reacts with the oxide layer, since the acid liquid contains a large number of bubbles, the bubbles churn inside the rubber pad 81 to constantly push the acid liquid to contact the oxide layer, the gas generated during cooling of the oxygen-free copper alloy plate 3 is used for driving the flow of the acid liquid, accelerating the reaction rate between the oxide layer and the acid liquid, and the acid liquid flows through the compression rod 812 and the lever 87, causing the rubber pad 81 to move up and down continuously; when the elastic rubber pad 81 moves downward, certain distance is spread on the surface of the oxygen-free copper alloy plate 3, increasing a cleaning range of the acid liquid, at the same time, continuous contraction and spreading of the rubber pad 81 push the acid liquid to move up and down continuously, enabling the acid liquid to constantly contact the surface of the oxygen-free copper alloy plate 3, further improving the reaction efficiency between the oxide layer and the acid liquid;
step 4: the pickled oxygen-free copper alloy plate 3 contacts the rotating polishing mechanism 9 for oxide layer removal, so that the oxide layer on the surface of the oxygen-free copper alloy plate 3 is removed, the oxygen-free copper alloy plate 3 continues to move and contacts the scouring mechanism 7 to remove the oxide layer on the side wall of the oxygen-free copper alloy plate 3 and clean the surface of the oxygen-free copper alloy plate 3; after being cleaned by the high-pressure nozzle 74, the oxygen-free copper alloy plate 3 undergoes pickling, polishing, and scouring again to further removal of the oxide layer, then, the water sprayed from the flushing nozzle 42 is used for thoroughly cleaning the oxygen-free copper alloy plate 3; the above operations are repeated to cool the oxygen-free copper alloy plate 3 inside the cooling box 1 and the pickling box 4 and remove the oxide layer; and
step 5: after thoroughly cleaning and drying the oxygen-free copper alloy plate 3, pre-finish rolling is performed and then the oxygen-free copper alloy plate 3 is sent into an annealing furnace for annealing treatment, the oxygen-free copper alloy plate 3 taken out of the annealing furnace is placed into the cooling box 1 and the pickling box 4 again to remove the oxide layer, and finally, after finish rolling the oxygen-free copper alloy plate 3, the oxygen-free copper alloy thick strip is obtained.

It can be known from common technical knowledge that the present invention can be implemented through other embodiments that do not depart from the essence or essential features of the present invention. Therefore, the above-disclosed embodiments are merely illustrative in all aspects and not restrictive. All changes within the scope of the present invention or equivalent to the scope of the present invention are included in the present invention.

What is claimed is:

1. Production and processing equipment for oxygen-free copper alloy thick strips, characterized by comprising a cooling box (1) and a pickling box (4), both the cooling box (1) and the pickling box (4) are internally provided with a transmission mechanism (2) for driving the movement of an oxygen-free copper alloy plate (3), and the cooling box (1) is internally provided with a relief mechanism (5) for rapidly cooling the oxygen-free copper alloy plate (3) and reducing the thickness of an oxide layer;
the relief mechanism (5) comprises conveying pipes (51) and a baffle plate (55), the baffle plate (55) with an arc-shaped edge is installed inside the top of the cooling box (1), and the conveying pipes (51) are symmetrically installed on upper and lower sides of the transmission mechanism (2) inside the cooling box (1);
a plurality of nozzles (52) and turning nozzles (53) are installed on an upper side of the conveying pipe (51) located at the lower side of the transmission mechanism (2), and a plurality of downward pressure nozzles (54) are installed at a bottom end of the conveying pipe (51) located at the upper side of the transmission mechanism (2);
inclination angles of the nozzles (52) increase sequentially from a middle position of the conveying pipe (51) to an edge position of the conveying pipe (51), and the turning nozzles (53) are obliquely fixed at two ends of the conveying pipe (51) and are located outside the nozzles (52);
distances between adjacent downward pressure nozzles (54) and inclination angles of the downward pressure nozzles (54) gradually increase from an edge position of the conveying pipe (51) to a middle position of the conveying pipe (51);
the cooling box (1) is internally provided with a pumping mechanism (6) for delivering water and gas to the interior of the pickling box (4), and the pickling box (4) is internally provided with a cleaning mechanism (8) for performing pickling treatment on the oxide layer;
the cleaning mechanism (8) comprises support rods (88), a plurality of support rods (88) are installed inside the pickling box (4), the support rods (88) are connected to a communicating pipe (810) through joints (89), the interior of each joint (89) is rotatably connected with a rotating shaft (811) and compression rods (812), enabling the rotating shaft (811) to rotate freely within the joint (89), a side wall of the rotating shaft (811) is fixedly connected with a plurality of compression rods (812);
a lever (87) is rotatably connected inside each joint (89) and the corresponding support rod (88), and a spherical end of the lever (87) abuts against a lower side of the compression rod (812);
a piston (85) and a sliding rod (83) are slidably connected inside the support rod (88) and a top end of the sliding rod (83) is sleeved inside the piston (85);
a bottom end of the lever (87) abuts against the top of the piston (85), and the lever (87) is installed on an inner side wall of the support rod (88) through a support (86);
a spring (84) sleeves a side wall of the sliding rod (83), and two ends of the spring (84) respectively abut against a bottom surface of the piston (85) and a bottom sealing surface of the support rod (88);
a bottom end of the sliding rod (83) is fixedly connected to a pressing plate (82), rubber pads (81) are installed on a side wall of the pressing plate (82), and a plurality of rubber pads (81) are slidably connected to a top surface and a bottom surface of the oxygen-free copper alloy plate (3); and
the pickling box (4) is internally provided with a polishing mechanism (9) for removing the oxide layer on a surface of the oxygen-free copper alloy plate (3), and two ends of the pickling box (4) are provided with scouring mechanisms (7) for removing the oxide layer at edges of side walls of the oxygen-free copper alloy plate (3).

2. The production and processing equipment for oxygen-free copper alloy thick strips according to claim 1, characterized in that the transmission mechanism (2) comprises a transmission rod (21) and a sliding cylinder (22), the transmission rod (21) is located at a tail end of the sliding cylinder (22) and extends to a tail end of the cooling box (1), the sliding cylinder (22) is arranged at an entrance of the cooling box (1), a plurality of discharging rollers (29) are provided at a transition position between the transmission rod (21) and the sliding cylinder (22), a plurality of protrusions (210) are installed on a side wall of the discharging roller (29), and lengths of the protrusions

(210) on surfaces of two adjacent discharging rollers (29) increase sequentially from top to bottom.

3. The production and processing equipment for oxygen-free copper alloy thick strips according to claim 2, characterized in that upper and lower two rows of transmission rods (21) rotating in opposite directions are arranged at two ends of the pickling box (4), one ends of two of the transmission rods (21) are each provided with a connecting gear (28) for changing the rotation direction of the corresponding transmission rod (21), and the connecting gears (28) are meshed with each other;
side walls of the cooling box (1) and the pickling box (4) are both connected with an installation box (26), the interior of the installation box (26) is rotatably connected with a main gear (27), the connecting gear (28) is meshed with the main gear (27), and one end of the main gear (27) is connected with a driving motor (23); and
chain wheels (24) are fixedly connected to side walls of the transmission rod (21) and the discharging roller (29), and a chain belt (25) is sleeved between the chain wheels (24).

4. The production and processing equipment for oxygen-free copper alloy thick strips according to claim 3, characterized in that a plurality of hydraulic rods (11) are installed on the side wall of the cooling box (1), one end of the hydraulic rod (11) is connected with a top plate (13) for pushing the oxygen-free copper alloy plate (3) to move upward and a push plate (12) for pushing the oxygen-free copper alloy plate (3) into the interior of the pickling box and
a limiting block (14) with a triangular side wall is installed on an inner side wall of the cooling box (1), and the limiting block (14) abuts against the side wall of the oxygen-free copper alloy plate (3).

5. The production and processing equipment for oxygen-free copper alloy thick strips according to claim 4, characterized in that the pumping mechanism (6) comprises a high-pressure water pump (63) and an air pump (64), the high-pressure water pump (63) and the air pump (64) are installed on the surface of the cooling box (1), the high-pressure water pump (63) is connected to the cooling box (1) and the pickling box (4) through a water pipe (66), a bottom end of the water pipe (66) is communicated with a steel pipe (62), and the steel pipe (62) is vertically connected with a floating plate (61).

6. The production and processing equipment for oxygen-free copper alloy thick strips according to claim 5, characterized in that the air pump (64) rapidly draws the gas inside the cooling box (1) into the interior of a pickling pipe (41) through an air supply pipe (65), funnel-shaped mixing plates are symmetrically installed inside the pickling pipe (41), and a stop block (45) is installed between the two mixing plates and
one end of the pickling box (4) is provided with a flushing pipe (43), the flushing pipe (43) is communicated with the water pipe (66) inside the pickling box (4), and a plurality of flushing nozzles (42) are installed at a bottom end of the flushing pipe (43).

7. The production and processing equipment for oxygen-free copper alloy thick strips according to claim 6, characterized in that the polishing mechanism (9) comprises fixed shafts (91) and box bodies (94), I-shaped box bodies are symmetrically installed on the surface of the pickling box (4), the interior of each box body (94) is rotatably connected with a first gear (95) and a second gear (96) that are meshed with each other, the first gear (95) is connected to the driving motor (23), and the diameter of the first gear (95) is larger than that of the second gear (96);
top ends of the first gear (95), the second gear (96), and the fixed shaft (91) are fixedly connected to the chain wheels (24); and
bottom ends of the fixed shafts (91) are respectively fixedly connected to a first grinding wheel (92) and a second grinding wheel (93), and the first grinding wheel (92) and the second grinding wheel (93) are arranged in a staggered manner.

8. The production and processing equipment for oxygen-free copper alloy thick strips according to claim 7, characterized in that between the adjacent cleaning mechanism (8) and the scouring mechanism (7), rotation directions of the first grinding wheel (92) and the second grinding wheel (93) are opposite, top ends of four of the fixed shafts (91) are fixedly connected with a third gear (97) for changing the rotation directions of the first grinding wheel (92) and the second grinding wheel (93), and adjacent third gears (97) are meshed with each other.

9. The production and processing equipment for oxygen-free copper alloy thick strips according to claim 8, characterized in that the scouring mechanism (7) comprises cylinders (71), a plurality of cylinders (71) are fixedly connected to an inner side wall of the pickling box (4), a middle part of a side wall of each cylinder (71) is communicated with the water pipe (66) inside the pickling box (4) through a connecting pipe (73);
a turbine (72) is rotatably connected inside the cylinder (71), the chain wheel (24) on a side wall of the turbine (72) is connected with the chain wheel (24) on a side wall of a speed-increasing gear (76) through the chain belt (25), the speed-increasing gear (76) is meshed with the main gear (27), and the diameter of the speed-increasing gear (76) is smaller than that of the main gear (27); and
the side wall of the cylinder (71) is communicated with a high-pressure nozzle (74) for removing the oxide layer on the side wall of the oxygen-free copper alloy plate (3), partition plates (75) with arc-shaped side walls are installed at upper and lower ends of the high-pressure nozzle (74), and the oxygen-free copper alloy plate (3) is slidably connected between the partition plates (75).

10. A processing method for processing using the processing equipment according to claim 9, characterized by specifically comprising the following steps:
step 1: placing high-purity cathode copper in a vacuum induction furnace for smelting, before smelting, vacuumizing for preheating and drying the high-purity cathode copper, using charcoal subjected to drying treatment as a covering agent, and introducing inert gas at the bottom of the induction furnace, performing smelting at 1150-1200° C., wherein during a smelting process, the inert gas makes the gas in copper liquid in the furnace enter inert gas bubbles, as the bubbles float to a surface of the copper liquid, the gas reacts with the charcoal covering inside the furnace to generate CO for removal; after complete melting, adding a rare earth purifying agent and a composite deoxidizer, adding magnesium and tin into the furnace, continuing stirring for 2-5 min, and standing for 20-30 min to obtain an oxygen-free copper alloy melt; pouring the oxygen-free copper alloy melt into a preheated mold to obtain an oxygen-free copper alloy ingot; proportions of the raw materials in parts by weight are: 100 parts of the high-purity cathode copper, 0.02-0.1 parts of the rare earth purifying agent, 0.1-0.5 parts of the composite deoxidizer, 0.004-0.008 parts of magnesium, and 0.005-0.01 parts of tin;
step 2: under the condition of 800-860 C., performing hot rolling on the oxygen-free copper alloy ingot to prepare an oxygen-free copper alloy plate (3), connecting the equipment to an external power supply, placing the hot-rolled oxygen-free copper alloy plate (3) on the surface of the sliding cylinder (22), and placing the oxygen-free copper alloy plate (3) cooled inside the cooling box (1) into the pickling box (4); placing the oxygen-free copper alloy plate (3) inside the cooling box (1), wherein operation of the relief mechanism (5) makes water flow rapidly along the surface of the oxygen-free copper alloy plate (3), accelerating the heat dissipation efficiency, quickly carrying away the temperature of the oxygen-free copper alloy plate (3) and the surrounding gas, and reducing the oxidation efficiency;
step 3: when the oxygen-free copper alloy plate (3) moves inside the pickling box (4), the oxygen-free copper alloy plate (3) slides over the side wall of the rubber pad (81), in this case, acid liquid mixes with the gas inside the cooling box (1) and enters the interior of the rubber pad (81); the acid liquid contacts the surface of the oxygen-free copper alloy plate (3) inside the rubber pad (81) and the acid liquid reacts with the oxide layer, since the acid liquid contains a large number of bubbles, the bubbles churn inside the rubber pad (81) to constantly push the acid liquid to contact the oxide layer, the gas generated during cooling of the oxygen-free copper alloy plate (3) is used for driving the flow of the acid liquid, accelerating the reaction rate between the oxide layer and the acid liquid, and the acid liquid flows through the compression rod (812) and the lever (87), causing the rubber pad (81) to move up and down continuously; when the elastic rubber pad (81) moves downward, certain distance is spread on the surface of the oxygen-free copper alloy plate (3), increasing a cleaning range of the acid liquid, at the same time, continuous contraction and spreading of the rubber pad (81) push the acid liquid to move up and down continuously, enabling the acid liquid to constantly contact the surface of the oxygen-free copper alloy plate (3), further improving the reaction efficiency between the oxide layer and the acid liquid;
step 4: the pickled oxygen-free copper alloy plate (3) contacts the rotating polishing mechanism (9) for oxide layer removal, so that the oxide layer on the surface of the oxygen-free copper alloy plate (3) is removed, the oxygen-free copper alloy plate

(3) continues to move and contacts the scouring mechanism (7) to remove the oxide layer on the side wall of the oxygen-free copper alloy plate (3) and clean the surface of the oxygen-free copper alloy plate (3); after being cleaned by the high-pressure nozzle (74), the oxygen-free copper alloy plate (3) undergoes pickling, polishing, and scouring again to further removal of the oxide layer, then, the water sprayed from the flushing nozzle (42) is used for thoroughly cleaning the oxygen-free copper alloy plate (3); repeating the above operations to cool the oxygen-free copper alloy plate (3) inside the cooling box (1) and the pickling box (4) and remove the oxide layer; and
step 5: after thoroughly cleaning and drying the oxygen-free copper alloy plate (3), performing pre-finish rolling and then sending the oxygen-free copper alloy plate (3) into an annealing furnace for annealing treatment, placing the oxygen-free copper alloy plate (3) taken out of the annealing furnace into the cooling box (1) and the pickling box (4) again to remove the oxide layer, and finally, after finish rolling the oxygen-free copper alloy plate (3), the oxygen-free copper alloy thick strip is obtained.
